(19) United States
(12) Patent Application Publication
(10) Pub. No.: US 2015/0332607 A1
(43) Pub. Date: Nov. 19, 2015

(54) System for Producing Tactile Images

(71) Applicant: VIEWPLUS TECHNOLOGIES, INC., Corvallis, OR (US)

(72) Inventors: John A. Gardner, JR., Corvallis, OR (US); Christian Heinrich Otto Herden, Westerkappeln (DE)

(73) Assignee: VIEWPLUS TECHNOLOGIES, INC., Corvallis, OR (US)

(21) Appl. No.: 14/710,955

(22) Filed: May 13, 2015

Related U.S. Application Data
(60) Provisional application No. 61/992,485, filed on May 13, 2014.

(51) Int. Cl. G09B 21/02; G09B 21/00

(52) U.S. Cl. CPC G09B 21/02; G09B 21/003

(57) ABSTRACT

A system for producing tactile images from a drawing or graphics file includes an image scanner or input device for importing and creating a digital file, which may be operated upon by software in a computer. The software has edge detection and color detection functions that may be adjusted to create an image file that may be provided to an embossing machine, which in turn prints a tactile image.

### BACKGROUND OF THE INVENTION

Braille is a tactile reading and writing system used by the blind. Words and letters written in braille appear as combinations of six or eight dot cells in which each cell contains a raised dot pattern that represents a letter or number. Braille documents are written by braille translators, which are computer programs that take text files and convert them to braille patterns. The braille patterns are printed on special paper using braille embossers, which can create the patterns of dots that may be sensed by touch. Braille conversion software and embossers are well known and are available from companies such as Viewplus Technologies of Corvallis, Oreg.

Many documents contain drawings and graphical content as well as text and numbers. For example, documents may contain bar graphs or pie charts that explain percentages, progress, or statistics. For the sighted, such documents are created in popular text/graphics formats such as PDF or Word, which render both text and graphics content. However, graphics are seldom rendered by braille translators in a form usable by most blind readers. Graphics either are described in words or are converted to a simpler form for tactile reading, usually by hand. This is a tedious and labor-intensive task, often using string, wax, and/or glue to form tactile images.

Software does exist for making tactile images. These can be embossed or printed on capsule paper. But, the software must take and use the image as it is. It cannot transform the image into a form more suitable for use with an embossing machine. Many images are too “busy”, containing detail that can be perceived with the eye, but which is often too complex to be perceived in the tactile sense. But currently, rendering software alone cannot remove unwanted or inappropriate detail from an image and place it in a usable form that may be sensed and understood through touch. Handwork is nearly always necessary.

Color presents an additional problem. While the text of a document may discuss color, for example stating that the color green in a pie chart represents cash on hand, there is no way for a blind person to know which portion of the pie chart is green. More importantly, there is no functionality in a braille translator to cause an embossing machine to emboss something that stands for a color inside the portions of a tactile image.

### BRIEF DESCRIPTION OF THE SEVERAL DRAWINGS

FIG. 1 is a block schematic diagram of a system for producing a tactile image document from a conventional image.

FIG. 2 is a flow chart diagram illustrating the operation of the system of FIG. 1.

FIG. 3 is a graphical representation of a screen in a user interface showing an image in which braille has been substituted for text but no graphics processing done.

FIG. 4 is a graphical representation of a screen in a user interface showing an image that has been adjusted to simplify detail by an intermediate amount.

FIG. 5 is a graphical representation of a screen in a user interface showing an image that has been processed for maximum simplification and an intermediate fill level.

FIG. 6 is a graphical representation of a screen in a user interface showing an image adjusted for maximum simplification and no change in fill level.

FIG. 7 is a graphical representation of a screen in a user interface showing an image with an eraser function activated.

### DETAILED DESCRIPTION OF PREFERRED EMBODIMENTS

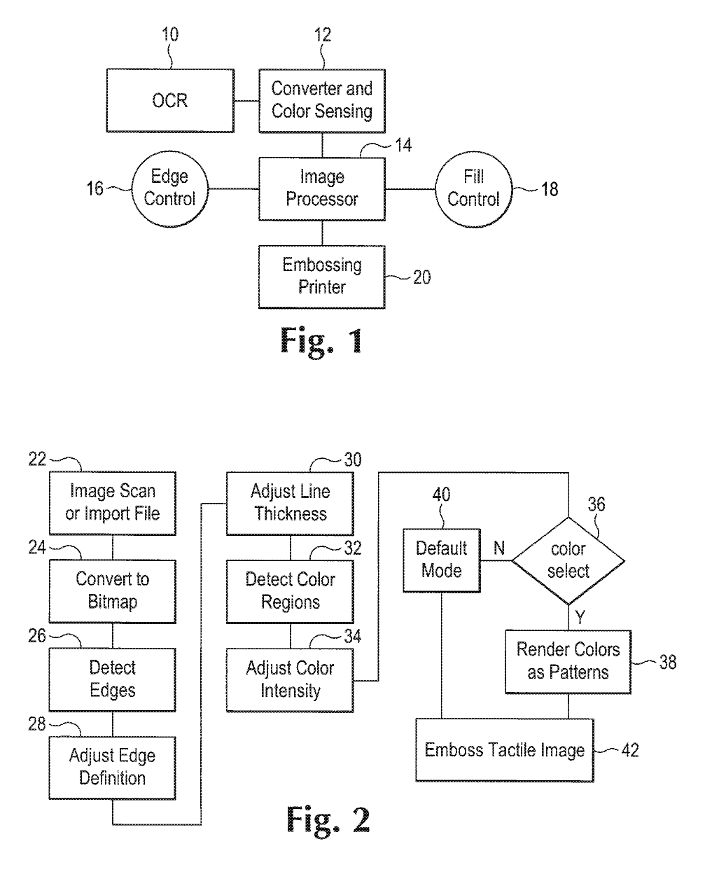

A system for producing tactile images includes a scanner, image-processing software on a general-purpose computer, and an embossing machine that can represent pixels or groups of pixels as raised dots that are perceptible by touch. Referring to FIG. 1, an optical reader 10 has capability for reading a document as an image. The optical reader 10 is coupled to a converter 12 that converts the image to a bitmap format. The scanned image is sent to an image processor 14. The image processor 14 may be a general purpose computer containing software that can adjust certain parameters of the bitmap image as will be discussed below, and translate image data into a form that can be used by an embossing printer. Two adjustments that are features of the software are an edge control 16, also called “simplification” herein, and a fill control 18. The fill control 18 regulates the amount of color in the image. The edge control is an edge contrast adjustment that determines which edges will be included in the embossed tactile document. The output of the image processor 14 can be coupled to an embossing printer 20, which will render the adjusted image as a tactile image that can be “read” by touch. This may be, for example, a Viewplus EmBraille embosser. Other types of embossers may be used as well, and the invention is not limited to use with any specific type of embossing printer or other technology for producing tactile images.

Referring to FIG. 2, a flowchart illustrates the steps taken by the system to produce tactile images in documents. At block 22, a document containing an image is scanned in an optical reader device. At block 24, the scanned image is converted to a bitmap image. Next, at block 26, the edges in the document are determined. A setting in the software establishes a difference threshold for adjacent pixels as is done with conventional edge detection technology and as a result, certain edges in the document are ignored. At block 28, the user may make adjustments to the edge definition of detected edges in the image to make it more suitable for producing a tactile image. With this adjustment, some edges may be eliminated so that only sharply defined or important edges remain. This may be necessary because certain types of edge definition that can be perceived visually are too “busy” for reproduction in a tactile document. The resolution that may be obtained through the sense of touch is below that which can be perceived with the eye.

Once edges have been determined at block 30, it is then necessary to adjust line thickness. There is a minimum line thickness that is appropriate for tactile images and thus adjusted edges must be increased in thickness to at least reach this minimum. The line thickness may be a predetermined width, for example, one tactile pixel wide which is 0.05 inches.

At block 32, regions of color are detected. This step includes both detecting the hue and intensity of the color. At block 34, the color intensity in detected color regions is adjusted. This function is accomplished with the fill control 18 in FIG. 1. The desired amount of color fill will be translated into a form suitable for use in the tactile image in one of two ways. At decision block 36, the user selects the mode in which colors will be rendered in the document. If the user chooses to render the actual colors on the tactile document, those colors are rendered in block 38 as predefined patterns within a bounded area. The patterns may be defined in any number of ways, for example by combinations of dots and lines, or if the embossing printer has the capability, by symbols that repeat according to some selected height or density within the area of color bounded by edges. An example would be a portion of a bar graph. If the text referred one of the bars as being “red” then the space inside the bar would consist of a pattern of symbols, dots, or lines that meant “red.”

If the user selects a default mode at block 40, color patterns are not used, and instead the embossed color region on the tactile document can use a convention in which dark colors are rendered as big dots, light colors are rendered as small dots and white regions contain no dots. Alternatively, a grayscale may be substituted for color in which the grayscale intensity is governed by the conventional algorithm:

I=4*g+2*r+b/7

where I is intensity, g is green content intensity, red is red content intensity, and blue is blue content intensity.

The final step in the process occurs at block 42 in which the embossing printer 20 creates the tactile document and produces a document with raised lines representing edges and appropriate color symbols or grayscale patterns according to the process adjustments made in the original scanned image.

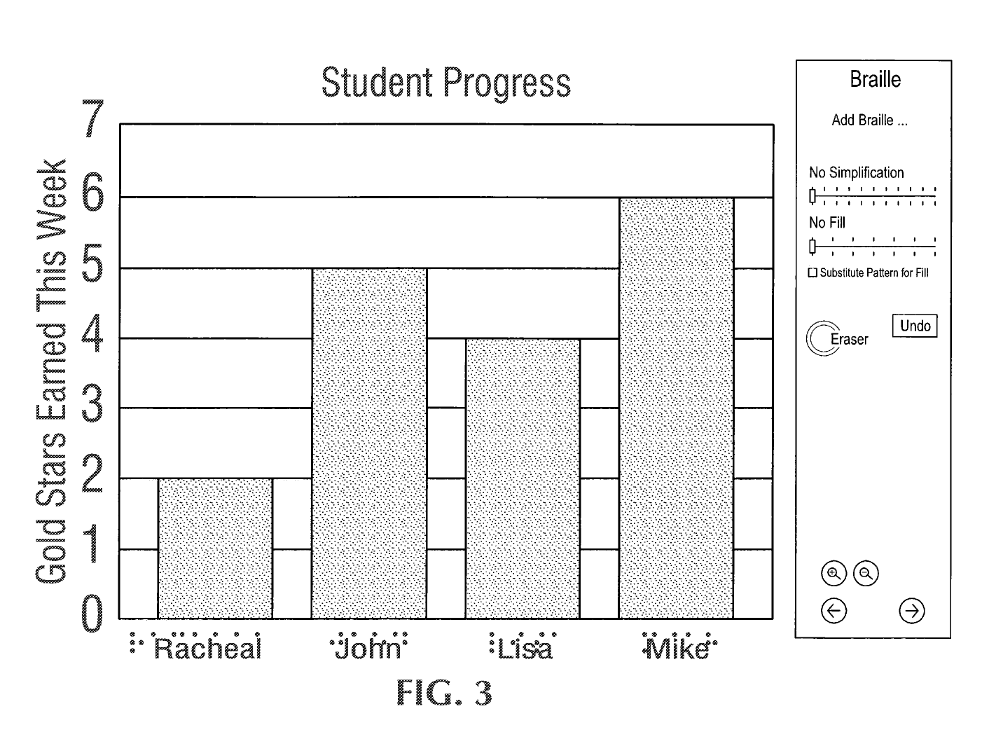

FIGS. 3-7 illustrate the actual use of the software program of the image processor 14. FIG. 3 is a screen rendering of an image that may be manipulated by the image processor 14, and is a simple bar graph displaying the progress of four students in the area of “gold stars earned”. In the graph, a different color is used for each of the four students. As the document initially appears, all controls are set to their default levels. Thus, the “simplification” slider is set to zero. This masks the “fill” slider and the selection box below it.

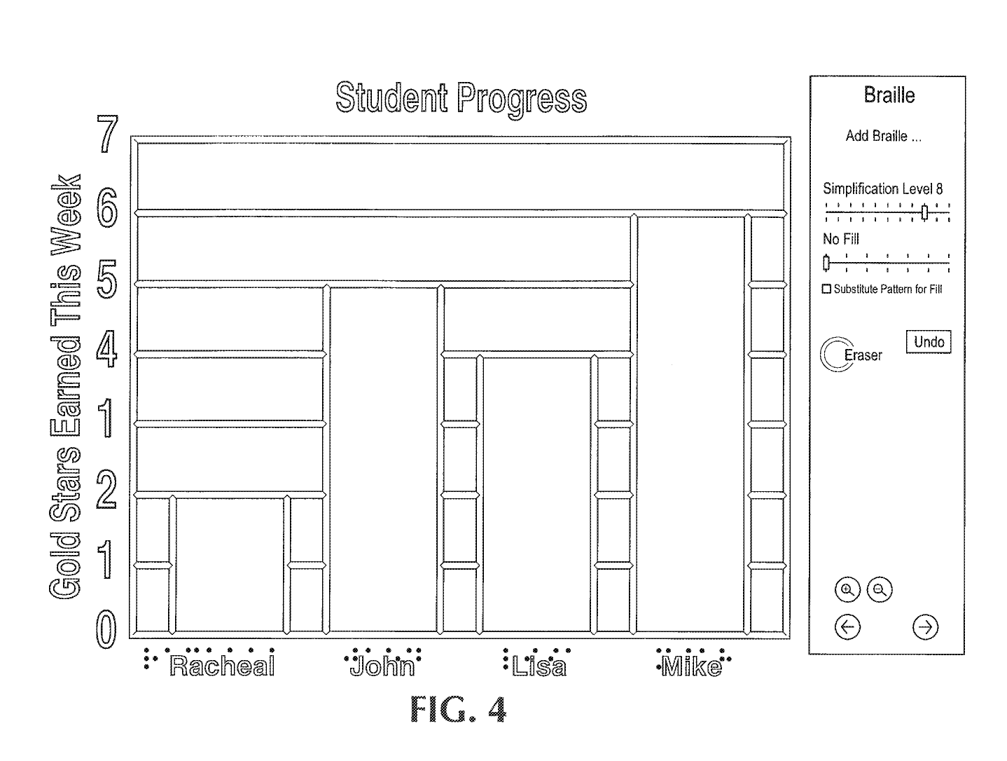

In FIG. 4, the Simplification Level slider has been advanced to the right, moving from zero to level 8. The Fill slider remains at zero. The Simplification slider control is an edge detection adjustment control. The object is to simplify the drawing so that selected edges are replaced by lines. This function is accomplished by setting a difference threshold in the examination of intensity of adjoining pixels. An algorithm resident in the software defines an “edge bit map” determined by two horizontal and two vertical scans. If the pixel contrast between a selected pixel and the one above, below, right or left of it exceeds a threshold as determined by the slider position, a gray pixel is placed in the edge bit map with the grayscale determined by the maximum magnitude of the contrast difference. If the contrast differences are all smaller than the slider-determined threshold, then the edge pixel is white. Thus, the slider setting is used to create lines where edges are determined in the original image by contrast only.

Once the edges have been defined, a line thickness algorithm increases the width of all edge lines from below a preset threshold to a defined edge thickness so that the lines become thick enough to be embossed and provide an image that can be sensed by touch. This is usually a line that is 0.05 inches thick.

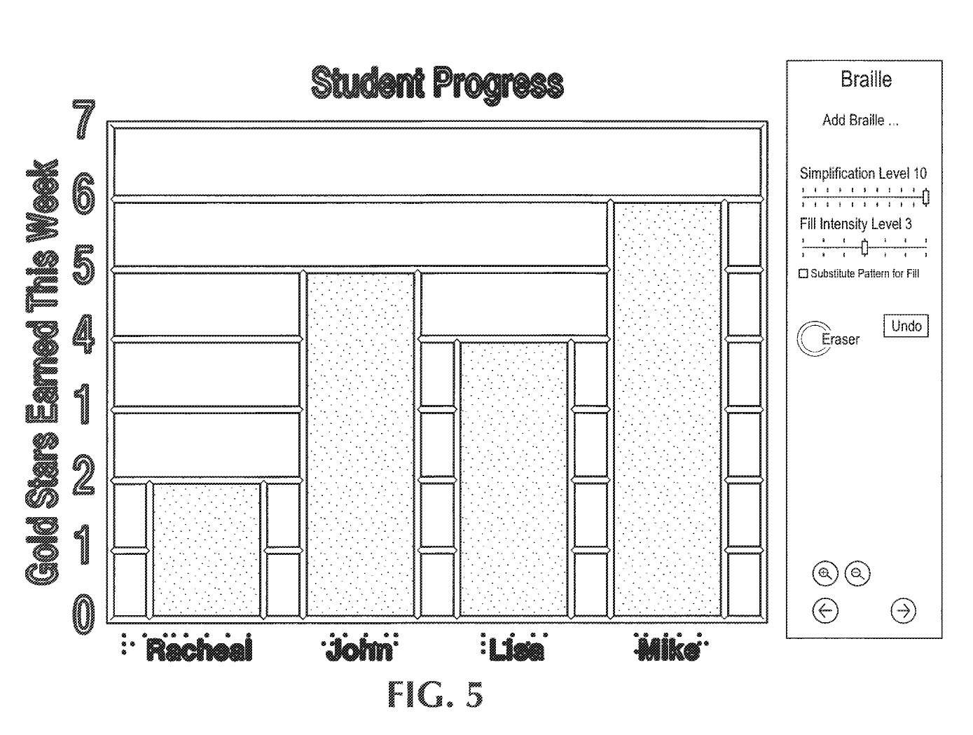

In FIG. 5, a screen rendering illustrates the use of the Fill control. The slider is shown in the position of Fill Intensity Level 3. This is a mid-level fill of the color inside the bars of the bar graph. If the box below, “Substitute Pattern for Fill,” is checked, the program will instruct the embossing printer to render the colors as a pattern on the tactile document. The pattern may be defined in various ways including preselected cells of dots and/or lines, or symbols if the embossing printer is capable of making symbols. There is no uniform convention that defines image colors in braille, so the user can define them in any way that is practical. When colors are rendered as patterns the degree of “fill” may be represented by the height and/or density of the features making up the pattern.

If the “Substitute Pattern” box is not checked, the system defaults to a convention in which the embossing printer will generate big dots for dark colors, small dots for light colors and no dots for white. Alternatively, the default condition may be the use of a grayscale as explained above.

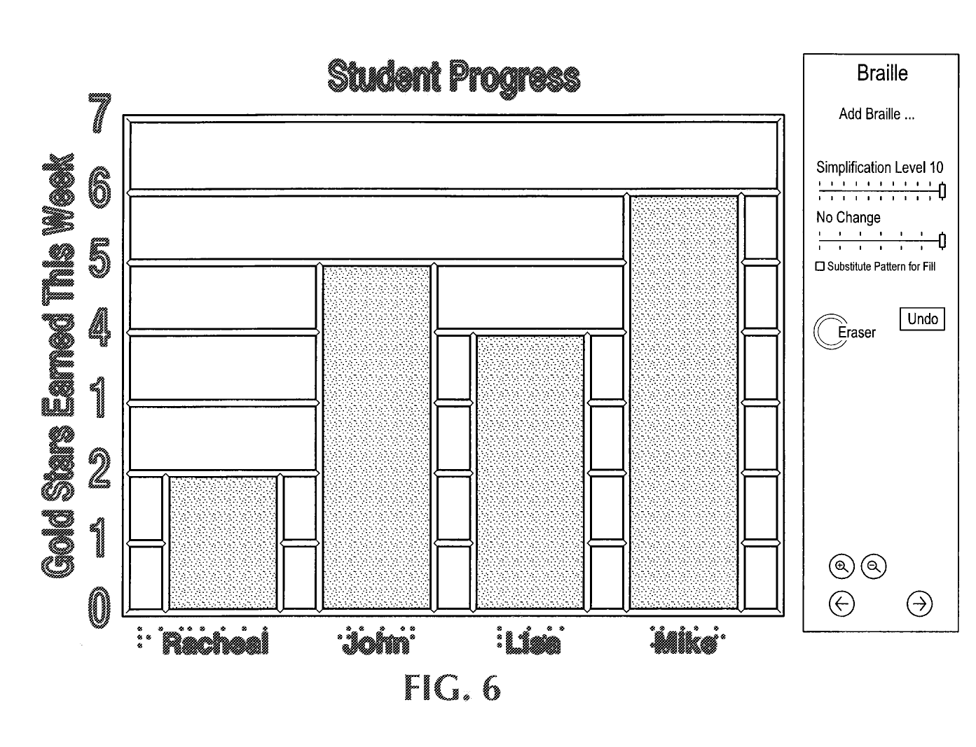

FIG. 6 illustrates the condition of maximum simplification and no change in the fill level from the original. Hence, all edges are represented by lines and colored regions have maximum fill. The user must then decide whether a fill pattern or a default rendering will be used to indicate color on the tactile document.

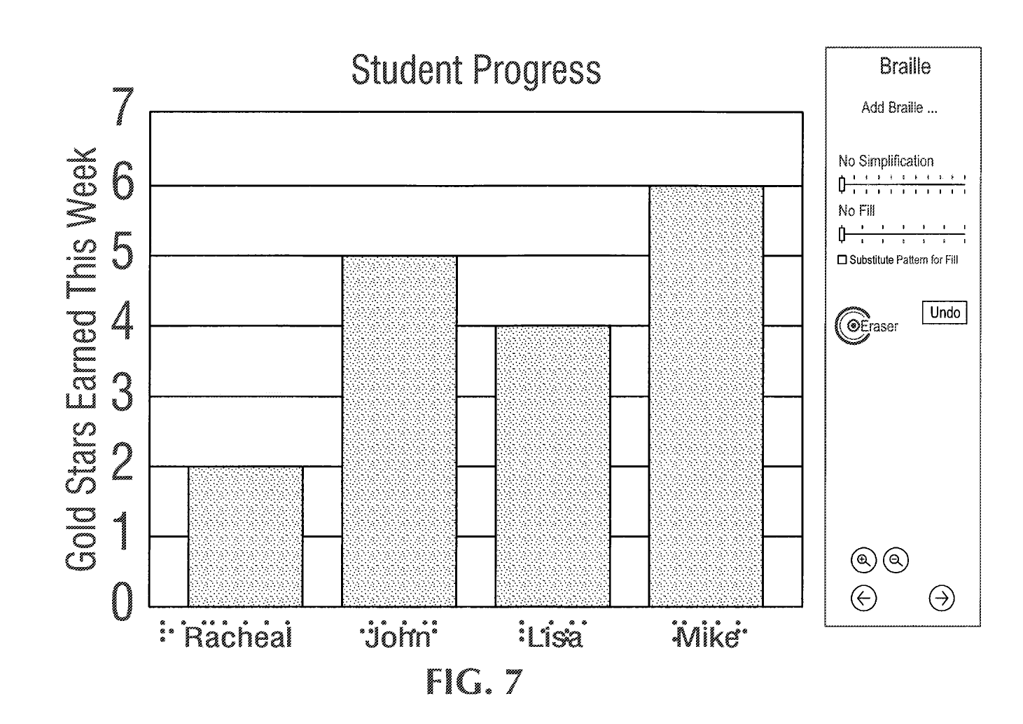

FIG. 7 illustrates other features of the image processor 14. The processor provides for adding text in the form of braille to the document. When the “add braille” box is clicked, a text tool appears and text, which will be rendered as braille in the tactile document, may be inserted as desired. In addition, an “eraser” button launches an eraser tool that permits the user to erase selected parts of the image.

Other variations of features of the system may also be employed. For example, different algorithms may be used to detect edges and provide selectable contrast. The “simplification” tool is essentially an edge contrast adjustment and several different methods exist for performing it in addition to that described above. Contrast thresholds between adjacent pixels may be changed, for example, to determine whether a selected pixel should be gray or white, and if gray, the scale value to be assigned. Line thickness may likewise be made adjustable if desired. For each line detected, a user may have the ability to determine how thick a particular line should be by adding or subtracting selectable intensity gray pixels on either side. This could be done in conjunction with the simplification slider or with a separately added control that made a line thicker or thinner. In addition, other tools may be added to the image processor such as a line drawing function, and/or the addition of colored, gray, or patterned regions. Some functions could be accomplished by adding other graphics software to the image processor. Many such graphics functions are available in programs such as Microsoft Paint or Photoshop. These could be linked with the image processing software described herein.

All of the processing functions described herein are translated to patterns of dots, lines, and/or symbols that can be embossed onto a document by an embossing printer that will print the tactile document.

The terms and expressions that have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A method for producing a tactile image which may be perceived through the sense of touch comprising the steps of:
(a) obtaining an image file in a digital format;
(b) converting the image file to a bitmap format to form a bitmap image file comprising an array of pixels;
(c) detecting edges of objects in the bitmap image file that satisfy preselected parameters and eliminating edges of objects that fall outside of said parameters;
(d) selecting predetermined ones of said pixels forming said edges and adjusting said pixels so as to define lines having thicknesses that may be perceived by touch; and,
(e) embossing the image defined in steps (c) and (d) onto a substrate to produce a tactile document.

2. The method of claim 1 further including the step of detecting hue and color of areas within said bitmap image file and rendering hue and color information within the tactile document as predefined tactically perceptible patterns within select bounded areas defined by said lines.

3. The method of claim 2 wherein said hue and color information is rendered as symbols within said select bounded areas.

4. The method of claim 2 wherein hue and color information is rendered in a grayscale.

5. The method of claim 1 wherein the thickness of said lines in said tactile document is at least 0.05 inches.

6. The method of claim 1 wherein step (c) is accomplished by setting a difference threshold of intensity between adjoining pixels forming an edge and eliminating pixels whose difference intensities fall below a selected level and by retaining pixels whose differences in intensity fall above said intensity.

7. The method of claim 1 wherein step (a) is accomplished by an optical character reader.

8. A method for producing a tactile image which may be perceived through the sense of touch comprising the steps of:
(a) obtaining an image file in a digital format;
(b) converting the image file to a bitmap format to form a bitmap image file comprising an array of pixels;
(c) determining the edges of objects within said bitmap image file and converting selected ones of said edges to lines of a preselected dimension;
(d) detecting hue and color of areas within said converted image file; and,
(e) rendering said lines on a tactile document and rendering said hue and color within said tactile document as predefined tactically perceptible patterns or recurring symbols within select bounded areas defined by said lines.

9. The method of claim 8 wherein said lines have thicknesses of at least 0.05 inches.

10. The method of claim 9 wherein step (e) is accomplished by use of an embossing machine.

11. The method of claim 8 wherein step (c) is accomplished by setting a difference threshold of intensity between adjoining pixels forming an edge and eliminating pixels whose difference intensities fall below a selected level and by retaining pixels whose differences in intensity fall above said intensity as grayscale pixels forming boundaries within said bitmap image.

12. The method of claim 11 wherein said lines are generated by adjusting the width of said grayscale pixels forming said boundaries to conform to a width that may be tactilely perceived.

13. The method of claim 8 wherein step (a) is accomplished by an optical character reader.

14. Apparatus for converting a visual image to a tactilely perceptible image comprising:
(a) an image input device;
(b) an embossing machine for creating said tactilely perceptible image; and,
(c) a computing device coupled between said image input device and said embossing device, said computing device having coded instructions resident therein for converting said visual image to a digital bitmap file, an edge detector for determining edges between objects in said bitmap file, a user interface providing an edge adjustment control for selecting predetermined edges in said bitmap file and for adjusting dimensions of said edges to form lines, a color and hue detector for detecting color and hue within said bitmap file, said user interface providing a color fill control for adjusting a desired level of color and hue intensity for areas within said lines of said tactilely perceptible image.

15. The apparatus of claim 14 wherein said image input device is an optical scanner.

16. The apparatus of claim 15 wherein said scanner is an OCR scanner.
